(19) United States
(12) Patent Application Publication
(10) Pub. No.: US 2018/0195967 A1
(43) Pub. Date: Jul. 12, 2018

(54) TEST INSTRUMENT AND METHOD OF CONTROLLING THE SAME

(71) Applicant: SAMSUNG ELECTRONICS CO., LTD., Suwon-si (KR)

(72) Inventors: Yu Ri SON, Gunpo-si (KR); Eun Jeong JANG, Suwon-si (KR); Jeong Min JO, Suwon-si (KR)

(73) Assignee: SAMSUNG ELECTRONICS CO., LTD., Suwon-si (KR)

(21) Appl. No.: 15/741,100

(22) PCT Filed: Oct. 21, 2015
(86) PCT No.: PCT/KR2015/011140

§ 371 Date: Dec. 29, 2017

(30) Foreign Application Priority Data
Aug. 25, 2015 (KR) 10-2015-0119530

(51) Int. Cl. G01N 21/75; G01N 35/00

(52) U.S. Cl. CPC G01N 21/75; G01N 35/00603; G01N 2021/751; G01N 2021/752; G01N 35/00712

(57) ABSTRACT

Disclosed herein are a test instrument and a method of controlling the same, capable of performing a basic test on a sample of a patient, determining whether to perform an additional test, and displaying interfaces associated with a progress level, a necessary time, etc. of the additional test on a display unit when the additional test is performed, thereby enabling a user to visibly recognize information associated with a performing process of each test. The test instrument includes: a detection unit configured to apply light to at least one chamber in which a reaction between a reagent and a sample occurs and to detect an optical signal from the chamber to test the sample held in a reaction device, a control unit configured to determine whether to perform a secondary test on the sample after a primary test is performed on the sample and to control to display a secondary test progress interface showing a progress level of the secondary test when the secondary test is performed, and a display unit configured to display a primary test progress interface showing a progress level of the primary test on the sample and to display the secondary test progress interface showing the progress level of the secondary test when the secondary test is performed on the sample.

### TECHNICAL FIELD

Embodiments of the present invention relate to a reaction device capable of making an extracorporeal diagnosis with a small amount of sample, and a test instrument for testing the sample.

### BACKGROUND ART

A variety of tests such as an immune test and a clinical chemistry test are performed on a sample of a patient for the purpose of an extracorporeal diagnosis. The immune test and the clinical chemistry test play a very important role in diagnosis of a state of the patient, treatment, and a prognostic judgment.

This extracorporeal diagnosis is chiefly made at a laboratory in a hospital. However, recently, for the purpose of rapidly analyzing samples in various fields such as environmental monitoring, food inspection, and medical diagnosis and carrying out an extracorporeal diagnosis irrespective of a place, miniaturization has recently been required of an extracorporeal diagnosis instrument.

Particularly, in the medical diagnosis, a degree of dependence upon a point-of-care (POC) blood analyzer using a disposable cartridge is raised, research and development of a small POC blood analyzer making a rapid accurate blood test possible is actively made all over the world.

### DISCLOSURE OF INVENTION

### Technical Problem

It is an aspect of the present invention to provide a test instrument and a method of controlling the same, capable of performing a basic test on a sample of a patient, determining whether to perform an additional test, and displaying interfaces associated with a progress level, a necessary time, etc. of the additional test on a display unit when the additional test is performed, thereby enabling a user to visibly recognize information associated with a performing process of each test.

### Solution to Problem

Additional aspects of the invention will be set forth in part in the description which follows and, in part, will he obvious from the description, or may be learned by practice of the invention.

In accordance with one aspect of the present invention, a test instrument includes a detection unit configured to apply light to at least one chamber in which a reaction between a reagent and a sample occurs and to detect an optical signal from the chamber to test the sample held in a reaction device, a control unit configured to determine whether to perform a secondary test on the sample after a primary test is performed on the sample and to control to display a secondary test progress interface showing a progress level of the secondary test when the secondary test is performed, and a display unit configured to display a primary test progress interface showing a progress level of the primary test on the sample and to display the secondary test progress interface showing the progress level of the secondary test when the secondary test is performed on the sample.

Here, the control unit may acquire optical property data on the sample held in the reaction device, detect a concentration of a target substance included in the sample based on the acquired optical property data, and determine whether to perform the secondary test. The test device may further include a storage unit storing data on a predetermined concentration of the target substance.

Further, the control unit may compare the detected concentration of the target substance with the predetermined concentration of the target substance and control to perform the secondary test when the detected concentration is lower or higher than the predetermined concentration.

Further, the optical property data may include at least one selected from the group consisting of absorbance, transmittance, reflectance, and luminance.

Further, the primary test progress interface and the secondary test progress interface may be displayed in a circular or polygonal doughnut graph.

Also, the display unit may simultaneously display the primary test progress interface and the secondary test progress interface when the secondary test is performed, and the secondary test progress interface may be displayed inside the displayed primary progress performing interface.

Further, the display unit may change the primary test progress interface into the secondary test progress interface when the secondary test is performed, and display the changed secondary test progress interface.

Further, the display unit may display a progress rate of the primary test on the primary test progress interface based on the progress level of the primary test, and display a progress rate of the secondary test on the secondary test progress interface based on the progress level of the secondary test.

Further, the display unit may change colors or forms of the primary and secondary test progress interfaces, and display progress rates of the tests.

Also, the display unit may display an interface through which a user selects whether to perform the secondary test.

In addition, the test instrument may further include a communication unit that transmits data on the primary or secondary test progress interface displayed on the display unit.

In accordance with another aspect of the present invention, a method of controlling a test instrument is a method of controlling the test instrument testing a sample held in a reaction device, and includes performing a primary test on the sample, displaying a primary test progress interface showing a progress level of the primary test on the sample, determining whether to perform a secondary test on the sample after the primary test is performed on the sample, and displaying a secondary test progress interface showing a progress level of the secondary test when the secondary test is performed.

Here, the determining of whether to perform the secondary test may include acquiring optical property data on the sample held in the reaction device, detecting a concentration of a target substance included in the sample based on the acquired optical property data, and determining whether to perform the secondary test.

Further, the determining of whether to perform the secondary test may include comparing the detected concentration of the target substance with a predetermined concentration of the target substance, and determining to perform the secondary test when the detected concentration is lower or higher than the predetermined concentration.

Further, the primary test progress interface and the secondary test progress interface may be displayed in a circular or polygonal doughnut graph.

Also, the displaying of the primary test progress interface and the secondary test progress interface may include simultaneously displaying the primary test progress interface and the secondary test progress interface when the secondary test is performed, and the secondary test progress interface may be displayed inside the displayed primary test progress interface.

Further, the displaying of the primary test progress interface and the secondary test progress interface may include changing the primary test progress interface into the secondary test progress interface when the secondary test is performed, and displaying the changed secondary test progress interface.

Further, the displaying of the primary test progress interface and the secondary test progress interface may include displaying a progress rate of the primary test on the primary test progress interface based on the progress level of the primary test, and displaying a progress rate of the secondary test on the secondary test progress interface based on the progress level of the secondary test.

Further, the displaying of the primary test progress interface and the secondary test progress interface may include changing colors or forms of the primary and secondary test progress interfaces, and displaying the progress rates of the tests.

In addition, the method may further include transmitting data on the primary or secondary test progress interface to an external device.

### Advantageous Effects of Invention

According to the embodiment of the disclosed invention, when an additional test is required on the sample of a patient, a progress level of a basic test and a progress level of the additional test are simultaneously displayed, and the user can visibly recognize a time required for the additional test.

Further, the progress levels or necessary times of the basic test and the additional test can be displayed through the screen of the miniaturized test instrument or the external device having a limited size, and thus be efficiently displayed on the display unit of a small medical instrument.

### BRIEF DESCRIPTION OF DRAWINGS

These and/or other aspects of the invention will become apparent and more readily appreciated from the following description of the embodiments, taken in conjunction with the accompanying drawings of which:

FIG. 1 illustrates an appearance of a test instrument according to an embodiment;

FIG. 2 illustrates an appearance of a reaction device inserted into the test instrument of FIG. 1 according to the embodiment;

FIG. 3 illustrates an appearance of a test instrument according to another embodiment;

FIG. 4 illustrates an appearance of a reaction device inserted into the test instrument of FIG. 3 according to the other embodiment;

FIG. 5 is a control block diagram illustrating a configuration of the test instrument according to the embodiment;

FIG. 6 illustrates a display unit in which an interface showing a progress level of a primary test according to an embodiment is displayed in a circular doughnut graph;

FIG. 7 illustrates a display unit in which the interface showing the progress level of the primary test according to the embodiment is displayed in a quadrangular doughnut graph;

FIG. 8 illustrates a display unit in which an interface by which a user selects whether to perform a secondary test according to an embodiment is displayed;

FIG. 9 illustrates a display unit in which the interface showing the progress level of the secondary test according to an embodiment is displayed in a circular doughnut graph;

FIG. 10 illustrates a display unit in which the interface showing the progress level of the secondary test according to an embodiment is displayed in a quadrangular doughnut graph;

FIG. 11 illustrates another embodiment in which the interface showing the progress level of the secondary test is displayed in the circular doughnut graph;

FIG. 12 illustrates another embodiment in which the interface showing the progress level of the secondary test is displayed in the quadrangular doughnut graph;

FIG. 13 illustrates a display unit in which an interface by which a user selects whether to perform the secondary test according to another embodiment is displayed;

FIG. 14 illustrates the interface showing the progress level of the secondary test according to an embodiment being displayed on an external device; and

FIG. 15 is a flow chart illustrating a method of controlling the test instrument according to an embodiment.

### BEST MODE FOR CARRYING OUT THE INVENTION

Reference will now be made in detail to the embodiments of the present invention, examples of which are illustrated in the accompanying drawings, wherein like reference numerals refer to like elements throughout.

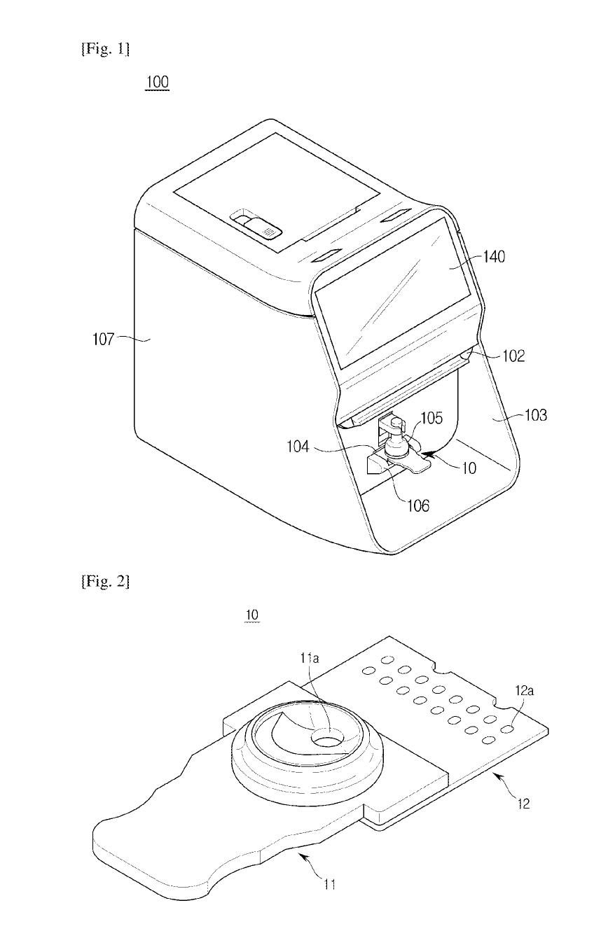

FIG. 1 illustrates an appearance of a test instrument according to an embodiment, and FIG. 2 illustrates an appearance of a reaction device inserted into the test instrument of FIG. 1 according to the embodiment.

A test instrument 100 is a miniaturized and automated instrument used to test a variety of samples such as environmental sample, bio-samples, and food samples. Specifically, when the test instrument 100 is used for an extracorporeal diagnosis of testing a living body sample obtained from a human body, the test instrument 100 enables a user such as a patient, a doctor, a nurse, or a clinical pathologist to rapidly make a point-of-care test (POCT) at a place, such as a house, a workplace, an ambulatory care room, a ward, an emergency room, an operating room, or a critically ill patient room, where the patient is present, in addition to a laboratory.

Meanwhile, a reaction device into which a sample is injected to react with a reagent includes a cartridge type in which the sample and the reagent move due to a capillary force, a disc type in which the sample and the reagent move due to a centrifugal force, a cuvette type in which measurement is done without movement of the sample and the reagent, and so on. According to the type of the reaction device, a structure or configuration of the test instrument can be changed. An exemplary example of FIG. 1 relates to the test instrument into which the cartridge type of reaction device is inserted.

According to the exemplary example of FIG. 1, the test instrument 100 is provided with a mounting section 103 that is a space in which a reaction device 10 is mounted. When a door 102 of the mounting section 103 is opened by sliding upward, the reaction device 10 can be mounted in the test instrument 100. As a specific example, a part of the reaction device 10 can be inserted into a predetermined insertion recess 104 formed in the mounting section 103.

The part of the reaction device 10 is inserted into a main body 107, and the rest is exposed to the outside of the test instrument 100 so as to be able to be supported by a support 106. When a pressing part 105 presses the reaction device 10, this facilitates the movement of the sample to a region where the reaction occurs.

When the reaction device 10 is completely mounted and the door 102 is closed, the test instrument 100 begins a test.

The cartridge type reaction device 10 inserted in to the test instrument 100 according to the exemplary example of FIG. 1 may have an appearance as illustrated in FIG. 2.

Referring to FIG. 2, the reaction device 10 according to the exemplary example may include a housing 11 and a platform 12 at which the sample and the reagent meet to cause the reaction.

The housing 11 supports the platform 12 and simultaneously enables a user to grasp the reaction device 10. The platform 12 may be coupled to the housing 11 in such a manner that it is bonded to a lower portion of the housing 11 or is fitted into a predetermined socket formed in the housing 11.

The housing 11 may be formed of a material that is easily molded and is chemically and biologically inert. For example, the material of the housing 11 may include various materials such as acrylic such as polymethyl methacrylate (PMMA), polysiloxane such as polydimethylsiloxane (PDMS), polycarbonate (PC), polyethylene such as linear low-density polyethylene (LLDPE), low-density polyethylene (LDPE), medium-density polyethylene (MDPE) or high-density polyethylene (HDPE), polyvinyl alcohol, very-low-density polyethylene (VLDPE), a plastic polymer such as polypropylene(PP), acrylonitrile butadiene styrene (ABS) or cyclic olefin copolymer (COC), glass, isinglass, silica, a semiconductor wafer, and so on.

The housing 11 is formed with an introduction hole 11a into which the sample is introduced. The user can drop the sample as a target to be tested into the introduction hole 11a using a tool such as a pipette or a dropper.

The platform 12 is formed with a plurality of chambers 12a. The same or different reagents are contained in the chambers 12a. For example, the reagents may be contained in such a manner that they are coated and dried in the chambers 12a. The sample introduced into the introduction hole 11a reaches the chambers 12a through channels (not illustrated) connecting the introduction hole 11a and the chambers 12a, and reacts with the reagents that have previously contained in the chambers 12a. It has already been described in FIG. 1 that the part of the reaction device 10 is inserted into the insertion recess 104 of the test instrument 100. Since the reactions of the reagents and the sample occur in the chambers 12a, the platform 12 may be inserted into the insertion recess 104, and the pressing part 105 may press the introduction hole 11a to facilitate introduction of the sample.

Although not illustrated in the drawings, the platform 12 may be formed in a structure in which three sheets are bonded. The three sheets can be divided into top, bottom, and middle sheets, of which the top and bottom sheets are printed with shading ink to be able to protect the sample moving to the chambers 12a from external light.

The top and bottom sheets may be formed of a film. The film used to form the top and bottom sheets may be one selected from a polyethylene film such as a VLDPE film, an LLDPE film, an LDPE film, an MDPE film or an HDPE film, a PP film, a polyvinyl chloride (PVC) film, a polyvinyl alcohol (PVA) film, a polystyrene (PS) film, and a polyethylene terephthalate (PET) film.

The middle sheet is formed of a porous sheet such as a cellulose sheet, and as such can serve as a vent, and by making the porous sheet of a hydrophobic material or performing a hydrophobic treatment on the porous sheet, an affect influencing the movement of the sample can be avoided.

In this way, when the platform 12 is formed in a three-layered structure, the top and middle sheets are formed with holes constituting the introduction hole 11a, and portions of the top and bottom sheets which correspond to the chambers 12a may be transparently processed. The portions of the top and bottom sheets corresponding to the chambers 12a are transparently processed to measure optical properties based on the reaction occurring in the chambers 12a.

The middle sheet is formed with thin channels. The sample introduced through the introduction hole 11a can move to the chambers 12a due to a capillary force of the channels.

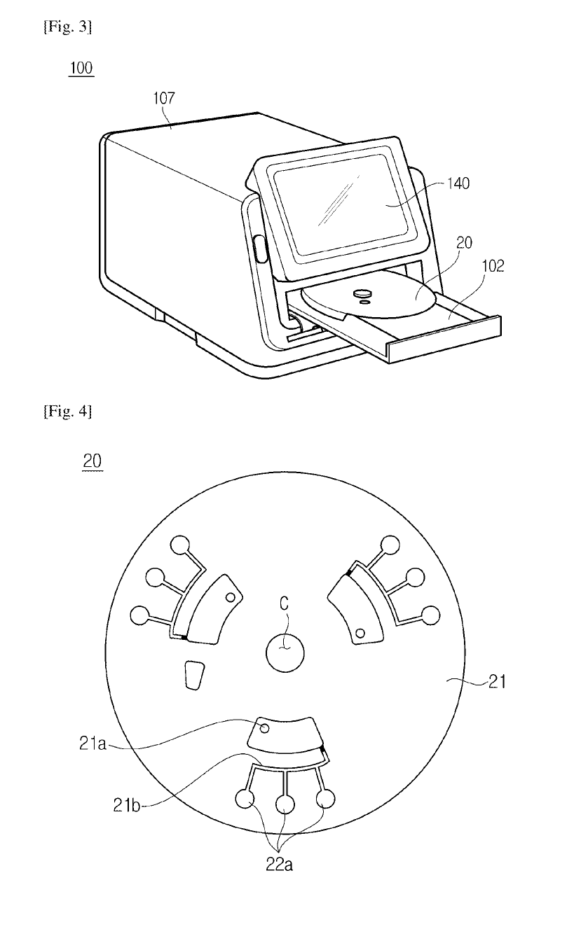

FIG. 3 illustrates an appearance of a test instrument according to another embodiment, and FIG. 4 illustrates an appearance of a reaction device inserted into the test instrument of FIG. 3 according to the other embodiment.

An exemplary example of FIG. 3 relates to a test instrument into which the disc type reaction device is inserted.

According to the exemplary example of FIG. 3, the test instrument 100 includes a tray 102 on which a disc type reaction device 20 can be placed. The placed reaction device 20 is inserted into the main body 107 of the test instrument 100 along with the tray 102. When the reaction device 20 is inserted, the test instrument 100 rotates the reaction device 20 to measure test results according to a type of the inserted reaction device 20, a type of the sample, or a sequence set by a test process.

Referring to FIG. 4, the disc type reaction device 20 may be made up of a rotatable platform 21 and structures formed on the platform 21. The structures include a plurality of chambers, each of which contain the sample or the same or different reagent, and channels connecting these chambers. The structures are formed in the reaction device 20. In the exemplary example, it is assumed that the reaction device 20 is formed of a transparent material, and the structures formed in the reaction device 20 can be observed when the reaction device 20 is viewed from above.

The platform 21 may be formed of a material that is easily molded and is biologically inert on its surface. This material may include various materials such as PDMS, a plastic polymer such as PMMA, PC, PP, PVA, or PE, glass, isinglass, silica, a silicon wafer, and so on.

However, the embodiment of the disclosed invention is not limited thereto. Any material may be the material of the platform 21 as long as it has chemical and biological stability and mechanical machinability. When the test result in the reaction device 20 is optically analyzed, the platform 21 may be adapted to further have optical transparency.

The platform 21 may be formed with introduction holes 21a into which the sample is introduced, chambers 22a in which the reagents are previously contained, and channels 21b, each of which connects the chambers 22a and the introduction holes 21a.

It was previously described in FIG. 3 that the test instrument 100 can rotate the reaction device 20. When a turntable transmitting a rotational force provided by the test instrument 100 is inserted into a central hole C formed in the center of the reaction device 20 and the reaction device 20 is rotated, the sample introduced through the introduction hole 21a can move to the chambers 22a due to a centrifugal force. Further, when the sample is a blood, centrifugation caused by rotation is possible. Therefore, structures for the centrifugation of the blood can be further formed on the platform 21.

In the disc type reaction device 20, the platform 21 may also be made up of a plurality of sheets. For example, when the platform 21 is made up of two sheets, a top and a bottom, intaglio structures corresponding to chambers or channels are formed in contact surfaces of the top and bottom sheets, and the two sheets are bonded. Thereby, a space capable of accommodating a fluid and a passage along which the fluid can move can be provided inside the platform 21. The bonding of the sheets may be performed by various methods such as adhesion using an adhesive or a double-sided tape, ultrasonic fusion, laser fusion, and so on.

Meanwhile, both the reaction devices 10 and 20 according to the exemplary examples of FIGS. 2 and 4 can induce quantitative analysis with only a small amount of sample. Further, since the sample or the reagent moves along the channel in the reaction device 10 or 20, the sample or the reagent may be a fluid form. Therefore, the reaction device 10 or 20 is referred to as a microfluidic device.

The appearance or type of the test instrument 100 is not limited to the exemplary examples of FIGS. 1 and 3. A device such as a spectrometer for testing a cuvette type of reaction device may be the test instrument 100 according to the embodiment. Any device for making a test in which an external temperature, an internal temperature, or a temperature of the sample has an influence on a result may be the test instrument 100 according to the embodiment.

As described above, the chambers 12a and 22a contain the same or different reagents, and the test can be simultaneously performed on various test items.

For example, each of the chambers 12a and 22a may contain a gamma-glutamyl transferase or transpeptidase (GGT) test reagent, a CREA test reagent, a TRIG test reagent, a CHOL test reagent, and an ALT test reagent, and thus a GGT test, a CREA test, a TRIG test, a CHOL test, and an ALT test can be simultaneously performed.

The test instrument 100 according to the embodiment and a method of controlling the same can be applied to various tests as described above. There is no limitation according to test purpose, but in the embodiment to be described below, the GGT test will be described as an example.

The GGT test is used to measure an activity of gamma-glutamyl transpeptidase in the blood. Since the activity mainly increases in obstructive jaundice, hepatoma, alcoholic liver disorder, or the like, measurement of a reaction rate using a synthetic substrate is widely used for this test. In the embodiment of the disclosed invention, by measuring a concentration of GGT, it can be determined whether a precise test is required. In general, when a value of the GGT concentration is lower than a reference value, an accurate result value can be derived in proportion to an increase in test time. Thus, in comparison of the value of the GGT concentration with the reference value, it can be determined whether the precise test or an additional detailed test is performed. In contrast, when the value of the GGT concentration is higher than the reference value, a desired accurate result value may not be derived. Even in this case, the progress of the precise test or the additional detailed test can be determined. Hereinafter, in the embodiments of the test instrument and the method of controlling the same, for the convenience of description, the description will be focused on a case in which a secondary test is performed when the value of the GGT concentration is lower than the reference value. However, even when the value of the GGT concentration is higher than the reference value, the secondary test may also be performed.

In an embodiment of the related art, when the test as described above is performed by the test instrument 100, the progress level of the test is displayed on a display unit 140 of the test instrument 100. There is a problem in that, when an additional test or a precise test is secondarily required after a primarily performed basic test is completed, no interface separately displaying the progress level of this secondary test is provided. Therefore, a user cannot visibly recognize a completion time and the progress status of the secondary test.

According to the embodiment of the disclosed invention, it is determined whether to perform the additional test or the precise test (hereinafter referred to as a “secondary test”) after the basic test or the previous test (hereinafter referred to as a “primary test”). When it is determined that the secondary test will be performed, an interface showing the progress level of the secondary test separately from an interface showing the progress level of the primary test may be displayed on the display unit 140. Hereinafter, the embodiment of the disclosed invention will be described in detail with reference to the drawings.

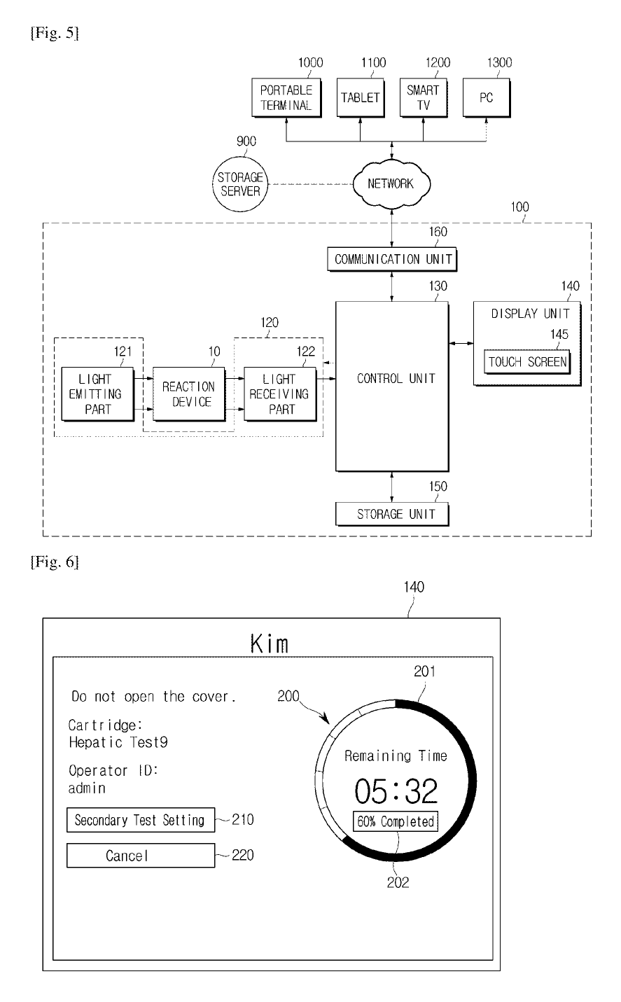

FIG. 5 is a control block diagram illustrating a configuration of the test instrument according to the embodiment.

Referring to FIG. 5, the test instrument 100 may include a detection unit 120 that applies light to the chambers 12a or 22a, detects light signals from the chambers 12a or 22a, and tests a sample contained in the reaction device 10 or 20, a control unit 130 that generally controls an operation of the test instrument 100, a display unit 140 that provides a user with information associated with a test result of the sample and the operation and control of the test instrument 100, a storage unit 150 that stores data associated with the control of the test instrument 100, and a communication unit 160 that allows the test instrument 100 to transceive data with an external server or allows the test result performed by the test instrument 100 to be sent to an external device.

As described above, the reaction device 10 is an instrument which contains the biochemical sample such as blood and in which a biochemical reaction for detecting a presence or concentration of a specimen included in the sample occurs. The detection unit 120 may include a light emitting part 121 and a light receiving part 122.

The light emitting part 121 may be implemented as a surface light source that has a wide light-emitting area and can radiate uniform light so as to be able to apply light to a predetermined region of the reaction device 10. For example, a back light unit may be used as the light emitting part 121. Further, the light emitting part 121 is a light source that is turned on and off at a predetermined frequency and may be implemented as a semiconductor light-emitting element such as a light emitting diode (LED) or a laser diode (LD) and a gas discharge lamp such as a halogen lamp or a xenon lamp.

The light receiving part 122 may detect light that radiates from the light emitting part 121 transmitted through or reflected from the sample contained in the chambers 12a of the reaction device 10, and generate electrical signals according to the intensity of light. The light receiving part 122 may include a depletion layer photo diode, an avalanche photo diode, a photomultiplier tube, or the like. Also, the light receiving part 122 may be implemented as a complementary metal-oxide-semiconductor (CMOS) image sensor or a charge-coupled device (CCD) image sensor.

The light emitting part 121 and the light receiving part 122 may be provided to face each other across the reaction device 10 or provided together at an upper or lower portion of the reaction device 10. Further, the light emitting part 121 and the light receiving part 122 may move in a direction in which the detection unit 120 is arranged in order to detect the reaction result. Power for moving the light emitting part 121 and the light receiving part 122 is provided from a motor (not illustrated) of the test instrument 100. The control unit 130 may control the motor to be driven to move the light emitting part 121 and the light receiving part 122.

An intensity or wavelength of the light radiating from the light emitting part 121 may be adjusted according to an instruction of the control unit 130. The light receiving part 122 can transmit the electrical signals generated by detecting the light to a processor 130. The light emitting part 121 and the light receiving part 122 may further include an analog-digital (AD) converter that converts the detection results of the light receiving part 122 into digital signals and outputs the digital signals to the control unit 130.

The control unit 130 may control an operation associated with the method of controlling the test instrument 100 according to the embodiment.

The control unit 130 may transmit a control signal to the display unit 140 such that an interface showing the progress level of the primary test performed by the test instrument 100 is displayed.

Further, the control unit 130 may determine whether to perform the secondary test after the primary test is performed by the test instrument 100, and transmit a control signal to the display unit 140 to display an interface showing the progress level of the secondary test when the secondary test is performed.

To be specific, the control unit 130 may acquire optical property data of the sample contained in the reaction device 10 based on the detection results from the detection unit 120. In this case, the sample corresponds to a sample, which is to be tested including a target substance, such as blood contained in the chambers 12a of the reaction device 10.

The sample tested in the test instrument 100 may include various states such as a fluid, a solid, and so on, but will be described as a fluid sample for the convenience of description. The fluid sample may be tested to detect a presence or concentration of the target substance included in the sample. In the embodiment of the disclosed invention, the target substance corresponds to the in-blood GGT as described above. For this test, a specific reaction between substances may be used. The reagent including a substance specifically reacting with the target substance is caused to react with the sample, and data showing optical properties of a reactant (hereinafter referred to as “optical property data”) is acquired. Thereby, the presence or concentration of the target substance can be detected.

At this time, the optical property may include absorbance, transmittance, luminance, or reflectance. The optical property data may be information about a change in the optical properties shown with the progress of a reaction between the sample and the reagent. In detail, the optical property data may include information about a change in absorbance, transmittance, luminance, or reflectance. Here, the absorbance, the transmittance, and the reflectance can be obtained by applying light to the reactant of the sample and the reagent to measure light transmitted through or reflected from the reactant, and refers to a level to which the reactant absorbs, transmits, or reflects the applied light. Further, the luminance can be obtained by applying light to the reactant, stopping the application of the light, and measuring light emitted from the reactant. The luminance refers to a level to which the reactant emits light, which is also called fluorescence.

The control unit 130 may detect a concentration of the target substance and compare it with a reference concentration stored in the storage unit 150. When the detected concentration of the target substance is lower or higher than the stored reference concentration, the control unit 130 may control the detection unit 120 to perform the secondary test. Further, the control unit 130 may control the display unit 140 such that various interfaces showing a performing process according to a progress status of the secondary test as a percentage can be displayed.

The control unit 130 may control the detection unit 120 to perform the secondary test based on an instruction which a user inputs. The control unit 130 may control the communication unit 160 to transmit data on the interface showing the progress level of the primary or secondary test displayed on the display unit 140 to an external device.

The control unit 130 may be installed in the main body 107. The control unit 130 may include a main processor, a graphic processor, and a memory.

The memory may store a control program or control data for controlling the operation of the test instrument 100, or temporarily store control instruction data which the main processor outputs or video data which the graphic processor outputs.

The memory may include at least one of a volatile memory such as a static random-access memory (SRAM) or a dynamic random-access memory (DRAM), and a non-volatile memory such as a flash memory, a read only memory (ROM), an erasable programmable ROM (EPROM), or an electrically erasable programmable ROM (EEPROM).

To be specific, the non-volatile memory may store the control program or the control data for controlling the operation of the test instrument 100. The volatile memory may fetch and temporarily store the control program or the control data from the non-volatile memory or temporarily store the control instruction data which the main processor outputs or the video data which the graphic processor outputs.

The graphic processor may convert video data that is transferred by the main processor or is stored in the memory into video data having a format capable of displaying the video data through the display unit 140, and transmit the converted video data to the display unit 140.

The main processor may process the data stored in the memory according to the control program stored in the memory. The main processor may be configured of a single processor or a plurality of processors.

The display unit 140 may display results of a test performed by the test instrument 100. As described above, since the reaction device 10 may be equipped with numerous chambers 12a, numerous test items may be detected from the single reaction device 10. When the numerous test items are detected, the display unit 140 may display detection results of the numerous test items. Further, the display unit 140 may provide various pieces of information associated with the test instrument 100 for a user. For example, information about setting, a progress status of the test, and results of the test of the test instrument 100 may be provided for the user.

The display unit 140 may display the interface showing the progress level of the primary test when the primary test is performed on the sample, and the interface showing the progress level of the secondary test when the secondary test is performed on the sample. The interface showing the progress level of the primary or secondary test may be displayed in various forms, for instance in a circular or polygonal form or in a form in which a circular or polygonal doughnut graph is filled with the progress of the test.

At this time, the display unit 140 may be carried out as an expression means such as a liquid crystal display (LCD), an LED, an organic LED (OLED), an active matrix organic LED (AMOLED), a flexible display, or a three-dimension display. Further, the display unit 140 may include a touch screen 145 receiving a touch instruction from a user. Hereinafter, for the convenience of description, the display unit 140 of the test instrument 100 will be carried out as the touch screen 145 by way of example.

The storage unit 150 may store data associated with the operation and control of the test instrument 100. To be specific, the storage unit 150 may store data associated with a concentration preset for the target substance included in the sample. As described above, in the embodiment of the disclosed invention, the control unit 130 detects the concentration of GGT, i.e. the target substance, to determine whether to perform the secondary test. The control unit 130 may detect the concentration of GGT and compare it with the reference concentration of GOT which is stored in the storage unit 150. The storage unit 150 may include, but not limited to, a high-speed RAM, a magnetic disc, an SRAM, a DRAM, or a ROM. Further, the storage unit 150 may be detachably mounted in the test instrument 100. For example, the storage unit 150 may include, but not limited to, a compact flash (CF) card, a secure digital (SD) card, a smart media (SM) card, a multimediacard (MMC), or a memory stick.

The communication unit 160 allows wired and wireless communication to be performed between the test instrument 100 and an external device. To be specific, the communication unit 160 may transmit data acquired by or stored in the test instrument 100 to the external device such that contents displayed on the display unit 140 of the test instrument 100 can be displayed on the external device. In the embodiment of the disclosed invention, the communication unit 160 transmits data associated with the interfaces displaying the progress levels of the primary and secondary tests displayed on the display unit 140 of the test instrument 100 to the external device, thereby enabling a user to visibly check the progress levels of the primary and secondary tests performed in the test instrument 100 through the external device. Here, the external device may include a portable terminal 1000, a tablet 1100, a smart TV 1200, or a PC 1300, and is not limited in its type as long as it is a device that is connected to the test instrument 100 by wire and/or wireless and has a display unit capable of displaying the same screen as the screen which the display unit 140 of the test instrument 100 can output. Further, the communication unit 160 may be connected to a storage sever 900 through a network. When the control unit 130 fetches data stored in the storage sever 900, the communication unit 160 may transmit the data to the control unit 130.

The communication unit 160 may include at least one of a Bluetooth communication module for one-to-one communication with a single external device or one-to-many communication with many external devices, a wireless fidelity (WiFi) communication module that gets access to a local area network (LAN) through a wireless access point, and a short-distance communication module such as a Zigbee communication module that establishes a short-distance communication network between the test instrument 100 and the external device.

However, the communication module included in the communication unit 160 is not limited to the Bluetooth communication module, the WiFi communication module, and the short-distance communication module, and may include other communication modules performing communication according to various communication protocols.

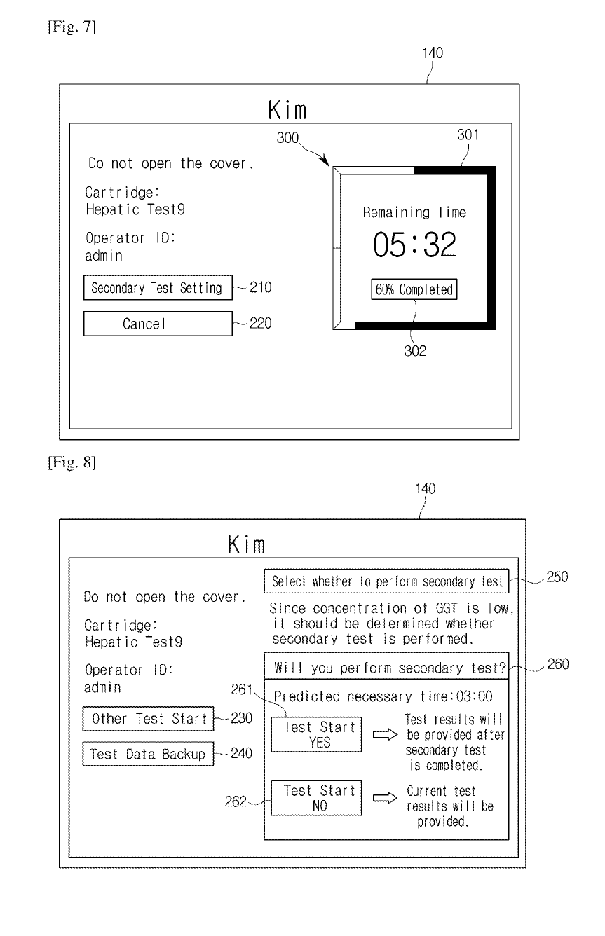

FIG. 6 illustrates a display unit in which the interface showing the progress level of the primary test according to an embodiment is displayed in a circular doughnut graph. FIG. 7 illustrates a display unit in which the interface showing the progress level of the primary test according to an embodiment is displayed in a quadrangular doughnut graph.

Referring to FIG. 6, the display unit 140 may display information associated with a test when the test is performed. For example, the display unit 140 may display a warning sentence, information (use identifier (ID), analysis cartridge type, etc.) about setting of the test, and so on.

When the primary test is performed on the sample, the display unit 140 may display a primary test progress interface 200. The primary test progress interface 200 may be displayed in the form of a circular tinier that shows a time remaining until the primary test is completed. A primary test progress graph 201 showing a test progress status may be displayed on the primary test progress interface 200 for the convenience of the user. Here, the primary test progress graph 201 may display a progress rate of the primary test in such a way that previously allocated segments are filled with the progress of the primary test.

Further, in the primary test progress interface 200, the time remaining until the primary test is completed may be expressed in figures, and a progress rate of the primary test that is currently in progress may be expressed in the form of a percentage 202. The primary test progress interface 200 illustrated in FIG. 6 shows that the primary test is currently in progress at about 60% using the primary test progress graph 201 and the percentage 202 and that the time remaining until the primary test is completed is 5:32. The user can visibly recognize a time required for the primary test and the time remaining until the primary test is completed through the primary test progress interface 200.

A secondary test setting button 210 for inputting a setting instruction for the secondary test may be displayed on the display unit 140. Since the display unit 140 is realized as the touch screen capable of receiving a touch instruction from a user, the user can touch the secondary test setting button 210 to input the setting instruction for the secondary test. Since the secondary test is performed by the determination of the control unit 130 or the manual control of the user, the user can input control instructions with respect to whether to perform the secondary test after the primary test is performed, whether to limit a time for the secondary test, and so on. Further, a cancel button 220 for stopping the primary test that is currently in progress may be displayed on the display unit 140. The user touches the cancel button 220 to input a control instruction to stop the primary test. Thereby, the user can stop the primary test to check results of the primary test performed up to a stop point in time.

FIG. 7 illustrates the display unit 140 in which a primary test progress interface 300 is displayed in a quadrangular doughnut graph. As in FIG. 6, a primary test progress graph 301 showing a progress status of the primary test may be displayed. In the primary test progress interface 300 displayed in the quadrangular doughnut graph, a time remaining until the primary test is completed may be expressed in figures, and a progress rate of the primary test that is currently in progress may be expressed in the form of a percentage 302. Details displayed on the primary test progress interface 300 are the same as in FIG. 6, and so a duplicate description thereof will be omitted.

The primary test progress interface showing the progress level of the primary test may be variously carried out in addition to the embodiments illustrated in FIGS. 6 and 7.

FIG. 8 illustrates a display unit in which an interface by which a user selects whether to perform the secondary test according to an embodiment is displayed.

As illustrated in FIG. 8, the display unit 140 may display a performing selection interface 250 that enables a user to select whether to perform the secondary test on the sample. FIG. 8 will be described with the assumption that the user manually selects whether to perform the secondary test.

As described above, when the detected concentration of GGT, i.e. the target substance, is lower or higher than the pre-stored reference concentration, the secondary test is performed. The secondary test may be automatically performed by control of the control unit 130 or be manually performed by selection of a user.

As in FIG. 8, an announcement that it should be determined whether to perform the secondary test because the concentration of GGT is low may be displayed on the display unit 140, and an interface 260 including a selection button capable of selecting whether to perform the secondary test may be displayed on the display unit 140.

A user can touch a button 261 for selecting to perform the secondary test to perform the secondary test. In this case, an announcement that results of the secondary test will be provided after a time required for the secondary test has elapsed, i.e. after the secondary test is completed, may be displayed. Further, the user can touch a button 262 for cancelling the performing of the secondary test to cancel the performing of the secondary test. In this case, an announcement that the results of the primary test are currently provided without performing the secondary test may be displayed.

Further, a button 230 for performing other tests may be displayed on the display unit 140. A control instruction for cancelling the test that is currently in progress to perform the other tests may be input by a touch input of the user. Here, the other tests may include a CREA test, a TRIG test, a CHOL test, and an ALT test other than the GGT test.

In addition, a test data backup button 240 for backing up test data may be displayed on the display unit 140. The user can touch the test data backup button 240 to store data on the results of the primary test in the storage unit 150 or the storage sever 900.

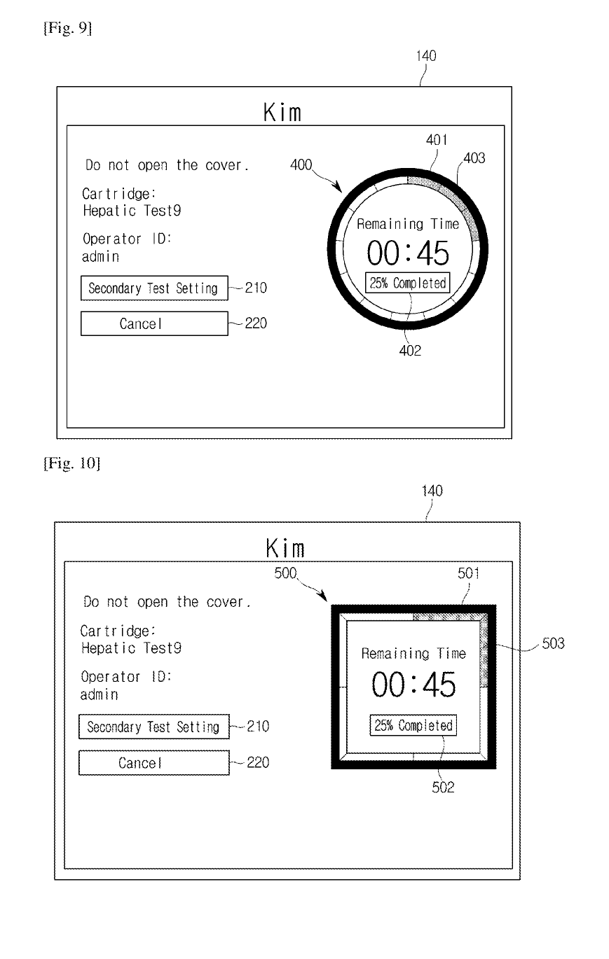

FIG. 9 illustrates a display unit in which the interface showing the progress level of the secondary test according to an embodiment is displayed in a circular doughnut graph. FIG. 10 illustrates a display unit in which the interface showing the progress level of the secondary test according to an embodiment is displayed in a quadrangular doughnut graph.

As described in FIG. 5, the control unit 130 may detect the concentration of GGT that is the target substance, compare the detected concentration with the reference concentration of GGT which is stored in the storage unit 150, and determine whether to perform the secondary test. In the related art, even when the secondary test should be performed on the target substance, no interface showing the progress level of the secondary test is displayed on the display unit 140, and thus the user has difficulty visibly recognizing the progress level of the secondary test.

According to the embodiment of the disclosed invention, when the control unit 130 determines to perform the secondary test or when the user selects to perform the secondary test by inputting his/her instruction, the display unit 140 may display a secondary test progress interface 400 showing a progress status of the secondary test. The secondary test progress interface 400 may include a primary test progress graph 401 and a secondary test progress graph 403, and be displayed in the form of a circular timer that shows a time remaining until the secondary test is completed.

As illustrated in the secondary test progress interface 400 of FIG. 9, the secondary test progress graph 403 may be displayed inside the primary test progress graph 401 showing that the primary test is completed. When all segments allocated to the primary test progress graph 401 are filled, this means that the primary test is completed. The secondary test progress graph 403 is different in color from the primary test progress graph 401, and may be displayed such that segments allocated thereto are filled with the progress of the secondary test.

The secondary test progress interface 400 is illustrated in FIG. 9 in such a manner that the primary test progress graph 401 and the secondary test progress graph 403 are displayed adjacent to each other in a circular shape. However, the primary test progress graph 401 or the secondary test progress graph 403 is not limited to the displayed form thereof and the color in which the segments allocated thereto are filled, and may be variously carried out.

Like the primary test progress interface, in the secondary test progress interface 400, the time remaining until the secondary test is completed may be expressed in figures, and a progress rate of the secondary test that is currently in progress may be expressed in the form of a percentage 402. The secondary test progress interface 400 illustrated in FIG. 9 shows that the secondary test is currently in progress at about 25% using the secondary test progress graph 403 and the percentage 402 and that the time remaining until the secondary test is completed is 45 minutes. The user can visibly recognize a time required for the secondary test and the time remaining until the secondary test is completed through the secondary test progress interface 400.

FIG. 10 illustrates the display unit 140 in which a secondary test progress interface 500 is displayed in a quadrangular doughnut graph. As in FIG. 9, a secondary test progress graph 503 showing a progress status of the secondary test may be displayed. In the secondary test progress interface 500 displayed in the quadrangular doughnut graph, a time remaining until the primary test is completed may be expressed in figures, and a progress rate of the secondary test that is currently in progress may be expressed in the form of a percentage 502. Details displayed on the secondary test progress interface 500 are the same as in FIG. 9, and so a duplicate description thereof will be omitted.

The secondary test progress interface showing the progress level of the secondary test may be variously carried out in addition to the embodiments illustrated in FIGS. 9 and 10.

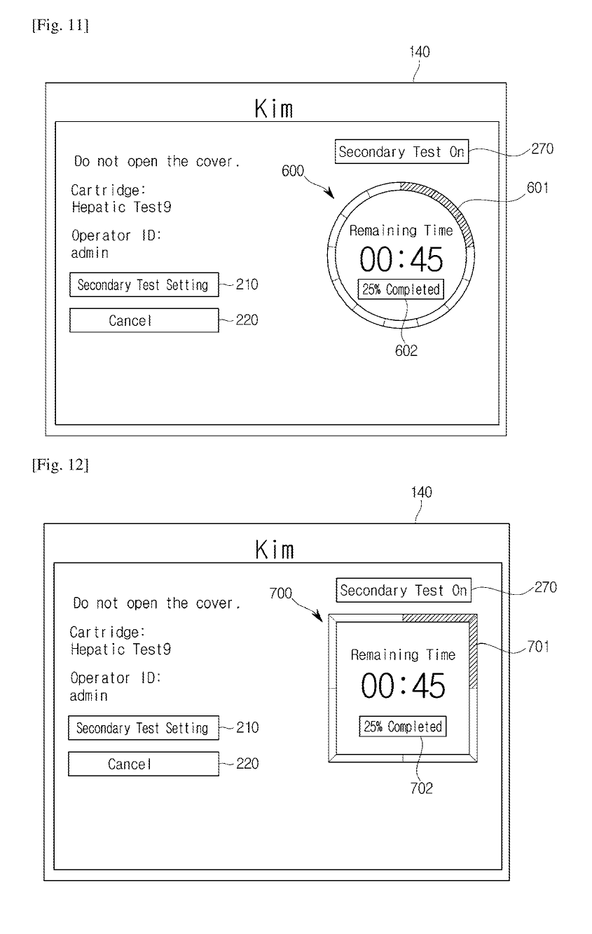

FIG. 11 illustrates another embodiment in which the interface showing the progress level of the secondary test is displayed in the circular doughnut graph. FIG. 12 illustrates another embodiment in which the interface showing the progress level of the secondary test is displayed in the quadrangular doughnut graph.

Referring to FIG. 11, when the control unit 130 determines to perform the secondary test or when the user selects to perform the secondary test by inputting his/her instruction, the display unit 140 may display a secondary test progress interface 600 showing a progress status of the secondary test. The secondary test progress interface 600 may include a secondary test progress graph 601 that, unlike in FIG. 9, is substituted for the primary test progress graph 401. That is, since it is determined that the secondary test is performed after the primary test is completed, only the secondary test progress graph 601 may be displayed without displaying the primary test progress graph 401 showing the progress level of the primary test.

However, a progress rate of the secondary test in the secondary test progress graph 601 may be displayed in a form other than that in which the progress rate of the primary test in the primary test progress graph 401 is displayed. That is, as illustrated in FIG. 11, the secondary test progress graph 601 may be displayed such that segments allocated thereto are filled with oblique lines with the progress of the secondary test. A user can visibly recognize a time required for the secondary test and a time remaining until the secondary test is completed through the secondary test progress interface 600 as illustrated in FIG. 11.

Referring to FIG. 12, a secondary test progress interface 700 showing the progress status of the secondary test may be displayed on the display unit 140 in a quadrangular doughnut graph. The secondary test progress interface 700 may display a secondary test progress graph 701 in the quadrangular doughnut graph. Unlike in FIG. 10, the displayed secondary test progress graph 701 is substituted for the primary test progress graph 501. A progress rate of the secondary test in the secondary test progress graph 701 may be displayed in a form other than that in which the progress rate of the primary test in the primary test progress graph 501 is displayed.

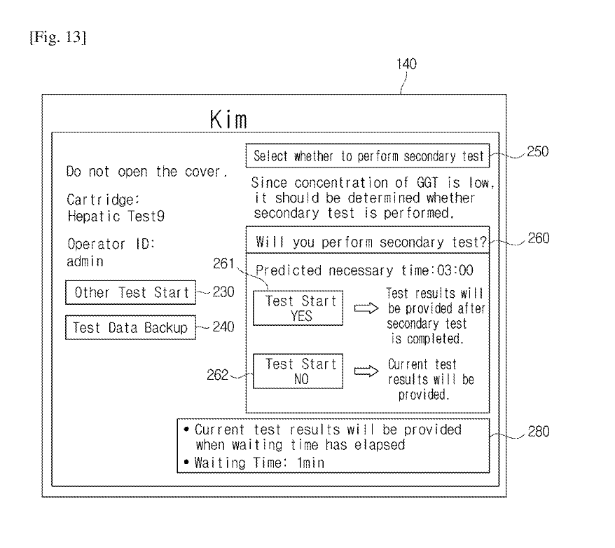

FIG. 13 illustrates a display unit in which an interface by which a user selects whether to perform the secondary test according to another embodiment is displayed.

Referring to FIG. 13, a performing selection interface 250 that enables a user to select whether to perform the secondary test on the sample may be displayed on the display unit 140, and an interface 260 including a selection button capable of selecting whether to perform the secondary test may be displayed on the display unit 140. FIG. 13 will be described on the assumption that the user manually selects whether to perform the secondary test.

Further, a waiting time provision interface 280 for displaying a wait time in which the user is required to input an instruction to select whether to perform the secondary test may be displayed on the display unit 140.

The secondary test should be performed after the primary test is completed. When a sample including a target substance is a blood, if it takes much time to initiate the secondary test, the blood coagulates, and the secondary test cannot be normally performed. Therefore, the control unit 130 may control the performing selection interface 250, which enables the user to select whether to perform the secondary test after the primary test is completed, to be displayed on the display unit 140, and simultaneously control the display unit 140 to display an announcement about a minimum time in which the user is required to select whether to perform the secondary test.

That is, as illustrated in FIG. 13, a wait time in which the user is required to select to perform the secondary test after the primary test is completed may be displayed to be one minute. If the user does not select whether to perform the secondary test after the lapse of the waiting time, the secondary test is not performed, and the results of the primary test that is currently completed may be provided for the user.

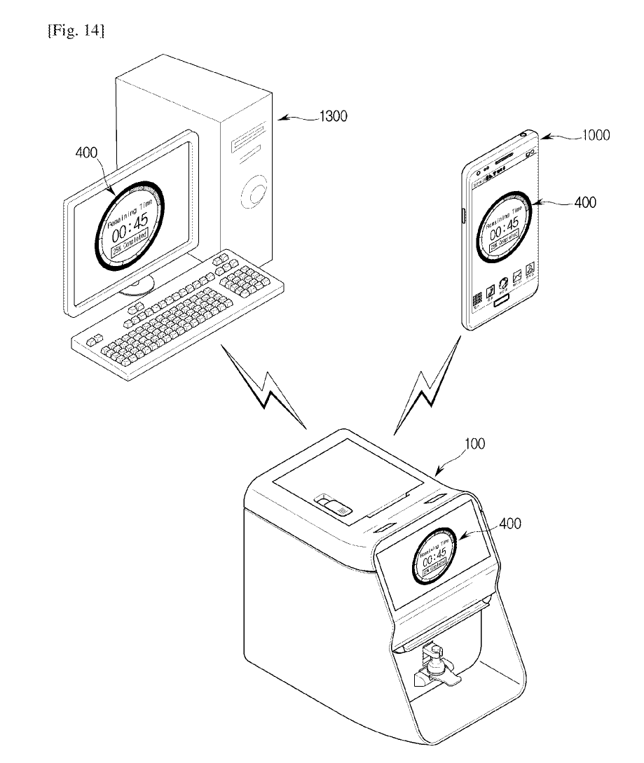

FIG. 14 illustrates that the interface showing the progress level of the secondary test according to an embodiment being displayed on an external device.

As described in FIGS. 9 and 10, when the secondary test is performed by the test instrument 100, the secondary test progress interface 400 showing the progress status of the secondary test may be displayed on the display unit 140. Here, the same screen as displayed on the display unit 140 of the test instrument 100 may be displayed on a display unit of the external device. Further, when the primary test is performed, the primary test progress interface 200 may also be displayed on the display unit of the external device.

To be specific, the communication unit 160 may transmit data on the primary test progress interface 200 or the secondary test progress interface 400 to the external device under the control of the control unit 130. The transmitted data may he stored in an external storage sever 900 through a network, be directly transmitted to the external device, and be displayed on the display unit of the external device.

The external device may include the portable terminal 1000, the tablet 1100, the smart TV 1200, or the PC 1300, and is not limited in its type as long as it is a device that has a display unit capable of displaying the same screen as the screen which the display unit 140 of the test instrument 100 can output. It is illustrated in FIG. 14 that the secondary test progress interface 400 is displayed on display units of the PC 1300 and the portable terminal 1000. The user can visibly check the progress levels of the primary and secondary tests performed by the test instrument 100 through the PC 1300 and the portable terminal 1000.

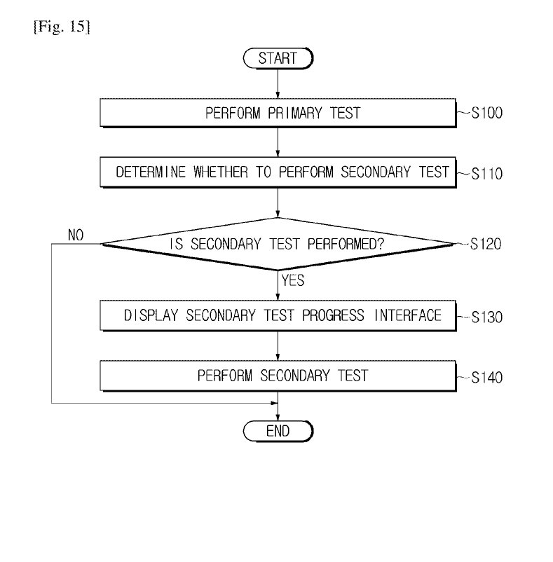

FIG. 15 is a flow chart illustrating a method of controlling the test instrument according to an embodiment.

The test instrument 100 may perform the primary test on the sample held in the reaction device 10 or 20 (S100). When the primary test is performed, the control unit 130 may control the display unit 140 to display the interface showing the progress level of the primary test as in FIGS. 6 and 7.

With the progress of the primary test, the control unit 130 may acquire optical property data of the sample held in the reaction device 10 or 20 based on results detected from the detection unit 120, and detect a concentration of a target substance included in the sample based on the acquired optical property data.

When the primary test is completed, the control unit 130 may compare the detected concentration of the target substance with the reference concentration stored in the storage unit 150, and determine to perform the secondary test when the detected concentration is lower or higher than the reference concentration (S110). Further, the user may touch the button 261 for selecting to perform the secondary test from the performing selection interface 250 for selecting whether to perform the secondary test as illustrated in FIG. 8, or touch the button 262 for cancelling the performing of the secondary test to cancel the performing of the secondary test.

The control unit 130 may determine whether to perform the secondary test based on the comparison of the detected concentration of the target substance or input of an instruction of the user (S120). When the detected concentration of the target substance is higher than the reference concentration of the target substance or when the user inputs an instruction to cancel the performing of the secondary test, the secondary test is not performed, and the primary test is completed.

In contrast, when the detected concentration of the target substance is lower than the reference concentration of the target substance or when the user inputs an instruction to select the performing of the secondary test, the control unit 130 may control the display unit 140 to display the secondary test progress interface 400 showing the secondary test as in FIGS. 9 and 12 (S130), and the test instrument 100 may perform the secondary test (S140). When the secondary test is completed, the test instrument 100 may provide the user with results of the secondary test through a screen displayed on the display unit 140.

According to the embodiment of the disclosed invention, when an additional test is required on the sample of a patient, a progress level of a basic test and a progress level of the additional test are simultaneously displayed, and the user can visibly recognize a time required for the additional test.

Further, the progress levels or necessary times of the basic test and the additional test can be displayed through the screen of the miniaturized test instrument or the external device having a limited size, and thus be efficiently displayed on the display unit of a small medical instrument.

Although a few embodiments of the present invention have been shown and described, it would be appreciated by those skilled in the art that changes may be made in these embodiments without departing from the principles and spirit of the invention, the scope of which is defined in the claims and their equivalents.

1. A test instrument comprising:
a detection unit configured to apply light to at least one chamber in which a reaction between a reagent and a sample occurs and to detect an optical signal from the chamber to test the sample held in a reaction device;
a control unit configured to determine whether to perform a secondary test on the sample after a primary test is performed on the sample and to control to display a secondary test progress interface showing a progress level of the secondary test when the secondary test is performed; and
a display unit configured to display a primary test progress interface showing a progress level of the primary test on the sample and to display the secondary test progress interface showing the progress level of the secondary test when the secondary test is performed on the sample.

2. The test instrument according to claim 1, wherein:
the control unit acquires optical property data on the sample held in the reaction device, detects a concentration of a target substance included in the sample based on the acquired optical property data, and determines whether to perform the secondary test; and
the test instrument further includes a storage unit storing data on a predetermined concentration of the target substance.

3. The test instrument according to claim 2, wherein the control unit compares the detected concentration of the target substance with the predetermined concentration of the target substance and controls to perform the secondary test when the detected concentration is lower or higher than the predetermined concentration.

4. The test instrument according to claim 2, wherein the optical property data includes at least one selected from the group consisting of absorbance, transmittance, reflectance, and luminance.

5. The test instrument according to claim 1, wherein the primary test progress interface and the secondary test progress interface are displayed in a circular or polygonal doughnut graph.

6. The test instrument according to claim 1, wherein the display unit simultaneously displays the primary test progress interface and the secondary test progress interface when the secondary test is performed, and the secondary test progress interface is displayed inside the displayed primary test progress interface.

7. The test instrument according to claim 1, wherein the display unit changes the primary test progress interface into the secondary test progress interface when the secondary test is performed, and displays the changed secondary test progress interface.

8. The test instrument according to claim 1, wherein the display unit displays a progress rate of the primary test on the primary test progress interface based on the progress level of the primary test, and displays a progress rate of the secondary test on the secondary test progress interface based on the progress level of the secondary test.

9. The test instrument according to claim 1, wherein the display unit changes colors or forms of the primary and secondary test progress interfaces, and displays progress rates of the tests.

10. The test instrument according to claim 1, wherein the display unit displays an interface through which a user selects whether to perform the secondary test.

11. The test instrument according to claim 1, further comprising a communication unit that transmits data on the primary or secondary test progress interface displayed on the display unit.

12. A method of controlling a test instrument testing a sample held in a reaction device, the method comprising:
performing a primary test on the sample;
displaying a primary test progress interface showing a progress level of the primary test on the sample;
determining whether to perform a secondary test on the sample after the primary test is performed on the sample; and
displaying a secondary test progress interface showing a progress level of the secondary test when the secondary test is performed.

13. The method according to claim 12, wherein the determining of whether to perform the secondary test includes acquiring optical property data on the sample held in the reaction device, detecting a concentration of a target substance included in the sample based on the acquired optical property data, and determining whether to perform the secondary test.

14. The method according to claim 13, wherein the determining of whether to perform the secondary test includes comparing the detected concentration of the target substance with a predetermined concentration of the target substance and determining to perform the secondary test when the detected concentration is lower or higher than the predetermined concentration.

15. The method according to claim 12, wherein the primary test progress interface and the secondary test progress interface are displayed in a circular or polygonal doughnut graph.

16. The method according to claim 12, wherein the displaying of the primary test progress interface and the secondary test progress interface includes simultaneously displaying the primary test progress interface and the secondary test progress interface when the secondary test is performed, and the secondary test progress interface is displayed inside the displayed primary test progress interface.

17. The method according to claim 12, wherein the displaying of the primary test progress interface and the secondary test progress interface includes changing the primary test progress interface into the secondary test progress interface when the secondary test is performed, and displaying the changed secondary test progress interface.

18. The method according to claim 12, wherein the displaying of the primary test progress interface and the secondary test progress interface includes displaying a progress rate of the primary test on the primary test progress interface based on the progress level of the primary test, and displaying a progress rate of the secondary test on the secondary test progress interface based on the progress level of the secondary test.

19. The method according to claim 12, wherein the displaying of the primary test progress interface and the secondary test progress interface includes changing colors or forms of the primary and secondary test progress interfaces, and displaying progress rates of the tests.

20. The method according to claim 12, further comprising transmitting data on the primary or secondary test progress interface to an external device.
